(19) United States
(12) Patent Application Publication
(10) Pub. No.: US 2020/0096744 A1
(43) Pub. Date: Mar. 26, 2020

(54) COMPOUND LENS WITH ASPHERIC-DIFFRACTIVE LENS ELEMENTS

(71) Applicant: Hewlett-Packard Development Company, L.P., Spring, TX (US)

(72) Inventor: Michael John Steinle, Fort Collins, CO (US)

(73) Assignee: Hewlett-Packard Development Company, L.P., Spring, TX (US)

(21) Appl. No.: 16/471,715

(22) PCT Filed: Apr. 24, 2017
(86) PCT No.: PCT/US2017/029217

§ 371 Date: Jun. 20, 2019

(51) Int. Cl. G02B 13/00; G02B 27/42; G02B 13/18; G02B 27/00

(52) U.S. Cl. CPC G02B 13/0055; G02B 27/0037; G02B 13/18; G02B 27/4205

(57) ABSTRACT

An example imaging system includes a compound lens. The compound lens may include a series of lens elements. Each of the lens elements has an aspheric surface on each opposite face. The last lens element of the series has a diffractive optic on a face. The compound lens 5 is to image an object in an object plane onto an image sensor at a resolution of at least 150 line pair/mm at a minimum modulation of 0.39 as applied to the object plane across a visible spectrum comprising red, blue and green wavelengths.

### BACKGROUND

Lenses are utilized in various imaging systems, such as computers, cellular phones and the like, to image an object onto an image sensor. A compound lens comprises a lens formed from a series of lens elements. Existing compound lenses do not offer high imaging resolution at a low cost in a small-volume over the visible spectrum.

### BRIEF DESCRIPTION OF THE DRAWINGS

FIG. 1 is a block diagram schematically illustrating portions of an example imaging system.

FIG. 2 is a flow diagram of an example method for imaging and object onto an image sensor.

FIG. 3 is a block diagram schematically illustrating portions of another example imaging system.

FIG. 4 is a block diagram schematically illustrating portions of another example imaging system.

FIG. 5 is a schematic diagram of another example imaging system.

FIG. 6 is a schematic diagram of another example imaging system.

FIG. 7 is a schematic diagram of another example imaging system.

FIG. 8 is a schematic diagram of another example imaging system.

FIG. 9 is a schematic diagram of another example imaging system.

FIG. 10 is a schematic diagram of another example imaging system.

FIG. 11 is a schematic diagram of another example imaging system.

FIG. 12 is a schematic diagram of another example imaging system.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed herein are example compound lenses and imaging systems that may provide high imaging resolution at a low cost in a small-volume over the visible spectrum. The disclosed compound lenses and imaging systems image an object in an object plane onto an image sensor at a resolution of at least 150 line pair/mm at a minimum modulation of 0.39 as applied to the object plane. The modulation (which is a specific point on the graph of “Modulation Transfer Function” vs. Frequency) is one example of a value for evaluating optical system performance. Modulation transfer function measures the contrast at various frequencies as an object is imaged onto an image plane. The mathematics for relating the Modulation Transfer Function between the object plane and image plane corresponds to the equation:

MTF)_{image plane}=MTF)_{object plane}/|m|,

wherein MTF)_{image} plane corresponds to the number of line pair/millimeter (in the image plane), MTF)_{object plane} corresponds to the number of line pair/millimeter (in the object plane) and the magnification m=image size/object size. The disclosed compound lenses and imaging systems image an object in an object plane onto an image sensor at a resolution of at least 150 line pair/mm at a minimum modulation of 0.39 as applied to the object plane despite an object, and its object plane, being within 15 mm from the first lens surface of the compound lens.

The disclosed example compound lenses and imaging systems image an object in an object plane onto an image sensor at a resolution of at least 150 line pair/mm at a minimum modulation of 0.39 as applied to the object plane while being very compact and small in size. For example, in some implementations, the compound lens may have a lens surface closest to the image plane of an image sensor by a distance of less than 19 mm. In some implementations, the object may be within 43 mm from the imaging surface of the imaging sensor.

The disclosed example compound lenses and imaging systems image an object in an object plane onto an image sensor at a resolution of at least 150 line pair/mm at a minimum modulation of 0.39 as applied to the object plane while being very compact and small in size. For example, in some implementations, the compound lens may have a lens surface closest to the image plane of an image sensor by a distance of less than 19 mm. In some implementations, the object may be within 43 mm from the imaging surface of the imaging sensor.

The disclosed example compound lenses and imaging systems provide magnifications of between −0.7 and −1.5. In one implementation, the compound lens has a magnification of between −7 and −1.0. In another implementation, compound lens has a magnification of between −1.0 and −1.5. In one implementation, compound lens has a magnification of −1.0. Such magnifications provide such high resolutions across the visual spectrum, including red, green and blue wavelengths of light.

The disclosed example compound lenses and imaging systems may include aspheric elements that correct for optical aberrations such as spherical aberrations, coma astigmatism and the like. To address chromatic aberration, where different colors or focus at different locations, at least one surface of the final lens element of the series of lens elements may include a diffractive optic or diffractive surface. Such an arrangement may achieve high performance, low cost and a reduced volume for the imaging system.

Disclosed herein is an example imaging system which may include a compound lens. The compound lens may include a series of lens elements. Each of the lens elements has an aspheric surface on each opposite face. The last lens element of the series has a diffractive optic on a face. The compound lens is to image an object in an object plane onto an image sensor at a resolution of at least 150 line pair/mm at a minimum modulation of 0.39 as applied to the object plane.

Disclosed herein is an example compound lens for an imaging system. The compound lens may comprise a series of lens which comprises a first lens element having a first surface to face an object and a second surface opposite the first surface. The first surface has a negative power. The series of lens may further comprise a last lens element having a first surface to face the first lens element sensor and a second surface to face an image sensor. The first surface of the last lens element and the second surface of the last lens element may each having a diffractive optic. The first surface of the first lens and the second surface of the last lens may be spaced by distance of less than 10 mm. The compound lens is to image an object in an object plane onto the image sensor at a resolution of at least 150 line pair/mm at a minimum modulation of 0.40 as applied to the object plane.

The level of resolution, compactness and low cost of the example compound lenses and imaging systems make the example compound lenses and imaging systems well-suited for a variety of imaging devices. For example, the disclosed example compound lenses and imaging systems are well-suited for use in scanners, two-dimensional printers, three-dimensional printers, additive manufacturing systems, cellular phones, computers and the like.

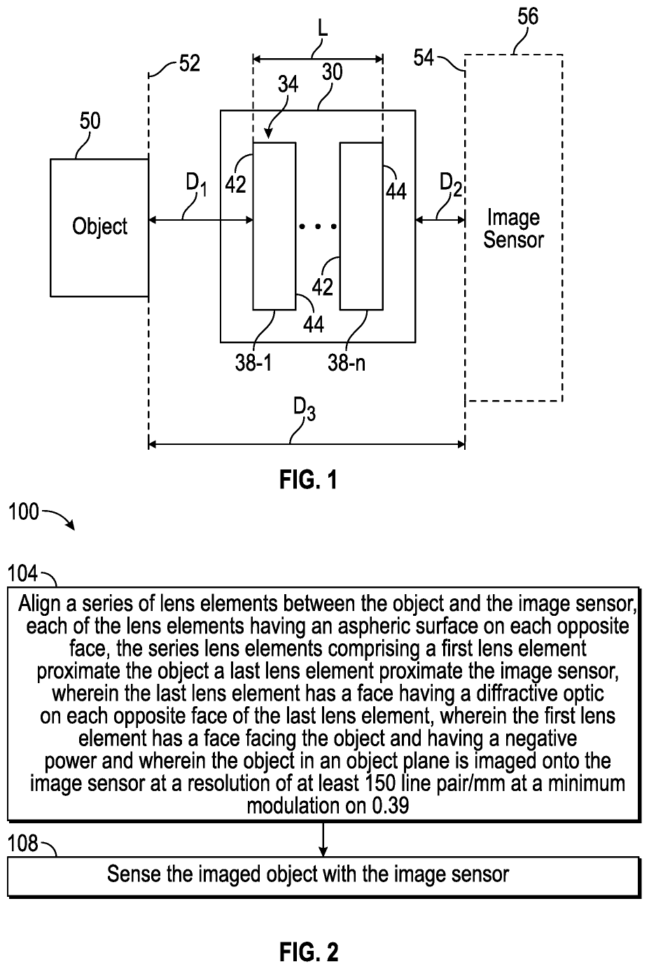

FIG. 1 is a block diagram schematically illustrating portions of an example compound lens 30 that may be used as part of an optical imaging system. Compound lens 30 comprises a series 34 of lens elements 38-1 . . . 38-n (collectively referred to as lens elements 38). Each of lens element 38 has an object side face 42 and a sensor side face 44. Lens elements 38 each have an aspheric surface on each opposite face 42, 44. The last lens element of the series 34, lens element 38-n, has a diffractive surface or diffractive optic on at least one face 42, 44. In one implementation, the last lens element of the series 34, lens element 38-n, has a diffractive surface or diffractive optic both faces 42, 44. The diffractive face or faces of the last lens element 38-n may be fabricated in a variety of fashions and may include kinoforms, binary and multiple binary steps.

The aspheric surfaces of the lens elements 38 may correct for optical aberrations such as spherical aberration, coma astigmatism and the like. The diffractive optic of the final lens element 38-n of the series may correct for chromatic aberration. The arrangement of lens elements 38 forming compound lens 30 images object 50 having an object plane 52 onto an image plane 54 of an image sensor 56 at a resolution of at least 150 line pair/millimeter at a minimum modulation of 0.39 as applied to the object plane 52.

In one implementation, compound lens 30 may image an object in an object plane onto an image sensor at a resolution of at least 150 line pair/mm at a minimum modulation of 0.39 as applied to the object plane while being very compact and small in size. For example, in some implementations, the face 42 of the lens element closest to the object plane 52, face 42 of lens element 38-1, may be spaced from object plane 52 by a distance D1 of less than 15 mm. In some implementations, the object may be within 43 mm from the imaging surface of the imaging sensor. In one implementation, the face 44 of the lens element closest to image plane 54, face 44 of lens element 38-n, may be spaced from image plane 54 by a distance D2 of less than 19 mm. In one implementation, compound lens 30 facilitates spacing of image plane 54 of image sensor 56 from object plane 52 by a distance D3 (sometimes referred to as a conjugate length) of less than 43 mm. In one implementation, the series of lens elements 38 forming compound lens 30 have an axial length L, the distance between face 42 of lens element 38-1 and face 44 of lens element 38-n of less than or equal to 10 mm. In some implementations, the series of lens elements 38 has an axial length L of less than or equal to 6 mm.

Compound lens 30 may provide magnifications of between −0.7 and −1.5. In one implementation, the compound lens 30 has a magnification of between −7 and −1.0. In another implementation, compound lens 30 has a magnification of between −1.0 and −1.5. In one implementation, compound lens 30 has a magnification of −1.0. Such magnifications are provided at the aforementioned resolution across the visual spectrum, including red, green and blue wavelengths of light.

In one implementation, series 34 of lens elements 38 comprises three lens elements (n=3). In such implementations, the first and middle lens elements, 38-1 and 38-2 may be formed from the same material of the last lens element, lens element 38-3 is formed from a different material. In one implementation, the first and middle lens elements have different Abbe numbers. An Abbe number is the amount of dispersion based on wavelength. A small Abbe number means light has a larger dispersion. The smaller the Abbe number, the larger the differences of indices of refraction for red, green and blue. In one implementation, the first and middle or second lens elements are formed from a material having a low index of refraction and a large Abbe number while the third or last lens element has a larger index of refraction and a lower Abbe number. For example, in one implementation, the first and middle lens elements may be formed from a glass such as SK16 glass (having an index of refraction of 1.620 at 587.6 nm; Abbe Number 60.32) while the last lens element 38-3 is formed from a glass such as SF4 (having an index of refraction of 1.755 at 587.6 nm; Abbe Number 27.38).

In another implementation, series 34 comprises four lens elements (n=4). In such implementations, compound lens 30 may provide a larger field-of-view as compared to a three lens element compound lens 30. For example, in one implementation, the aforementioned three lens element compound lens 30 may provide a field-of-view of 5 mm×5 mm. A four lens element compound lens 30 may provide a field-of-view of 10 mm×10 mm.

FIG. 2 is a flow diagram of an example method 100 for imaging an object onto an imaging sensor. Method 100 facilitates the imaging of an object using an imaging system or compound lens that provides high imaging resolution at a low cost in a small-volume over the visible spectrum. Although method 100 is described as being carried out with compound lens 30 described above, it should be appreciative that method 100 may be carried out with any of the compound lenses and imaging systems described in this disclosure or similar compound lenses/imaging systems.

As indicated by block 104, a series 34 of lens elements 38 are aligned between an object 50 and an image sensor 56. Each of the lens elements 38 has an aspheric surface on each opposite face 42, 44. The series 34 of lens elements 38 comprises a first lens element 38-1 proximate the object 50 and a last lens element 38-n proximate the image sensor 56. The last lens element 38-n has a a diffractive optic on each opposite face 42, 44 of the last lens element 38-n. The first lens element 38-1 has a face 42 facing object 50 that has a negative power. The object 50 in the object plane 52 is image onto the image sensor 56 at a resolution of at least 150 line pair/millimeter at a minimum modulation of 0.39.

As indicated by block 108, the object imaged upon image sensor 56 is sensed by the image sensor 56.

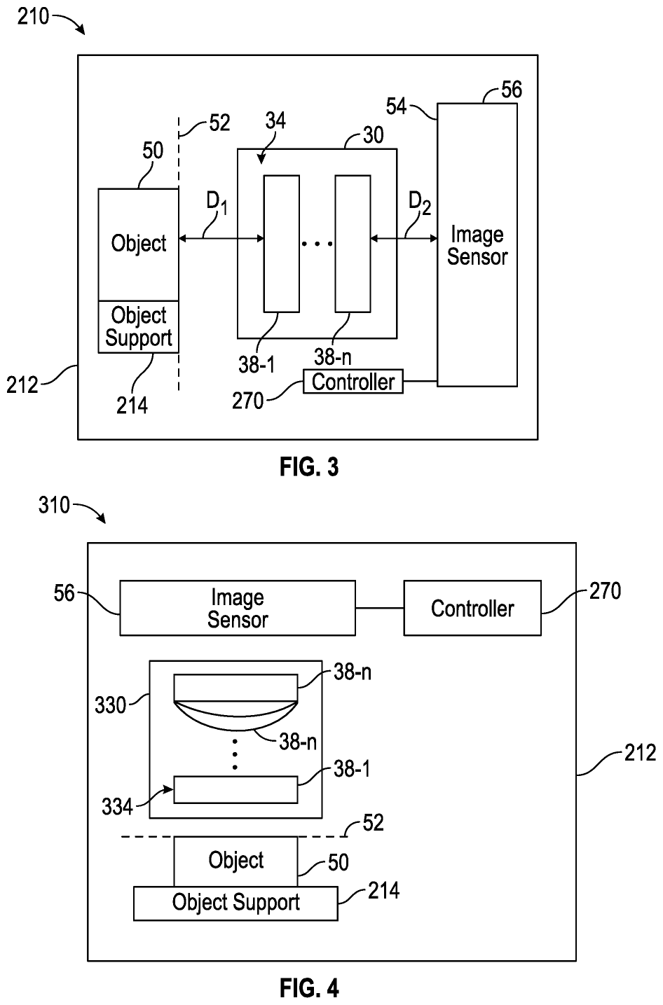

FIG. 3 is a block diagram schematically illustrating portions of an example imaging system 210 that comprises compound lens 30 described above. As illustrated by FIG. 3, the example imaging system 210 additionally comprises housing 212, object support 214 and controller 270. Housing 212 comprises a framework, enclosure or other structures that support and retain the remaining components of image system 210 with respect to one another. Housing 212 supports compound lens 30 relative to image sensor 56 and relative to object support 214.

Object support 214 supports the object 50 (schematically illustrated) to be imaged. In one implementation, object support 214 comprises a platen upon which the object, such as a sheet of media, rests during imaging. In another implementation, object support 214 comprises a bed supports an overlying layer or multiple layers of build material, such as when imaging system 210 is part of an additive manufacturing device that selectively coalesces powder or particulate build material to form three-dimensional products. In another implementation, object support 214 may comprise a drum or roller supporting a sheet or a web which is to be imaged. In yet other implementations, object support 214 may have other shapes are be provided by other structures.

In the example illustrated, housing 212 takes advantage of the imaging properties of compound lens 30, providing a compact size for imaging system 210. Housing 212 supports elements 38 of the lens compound lens 30, object support 214 and image sensor 56 at locations relative to one another such that imaging system 210 has a compact size while still providing imaging of object 50 onto image sensor 56 at a resolution of at least 150 line pair/mm at a minimum modulation of 0.39 as applied to the object plane. In one implementation, housing 212 supports elements 38 of the lens compound lens 30, object support 214 and image sensor 56 at locations relative to one another such that imaging system 210 has a compact size while still providing imaging of object 50 onto image sensor 56 at a resolution of at least 150 line pair/mm at a minimum modulation of 0.40 as applied to the object plane with a magnification of −1 and with a field-of-view of at least 5 mm×5 mm.

Housing 212 supports object support 214 such that the object 50 to be supported by object support 214 is spaced from the face 42 of the lens element closest to the object plane 52, face 42 of lens element 38-1, by the distance D1 of less than 15 mm. In some implementations, housing 212 locates object support 214 such that the object 50 may be supported within 43 mm from the imaging surface 54 of the imaging sensor 56. In one implementation, housing 212 supports compound lens 30 and image sensor 56 relative to one another such that the face 44 of the lens element closest to image plane 54, face 44 of lens element 38-n, is be spaced from image plane 54 by a distance D2 of less than 19 mm. In one implementation, housing 212 locates object support 214, compound lens 30 and image sensor 56 such that image plane 54 of image sensor 56 is spaced from object plane 52 by a distance D3 (sometimes referred to as a conjugate length) of less than 43 mm.

In one implementation, housing 212 supports the series 34 of lens elements 38 of compound lens 30 relative to one another and relative to objects 424 and image sensor 56 such that the series of lens elements 38 forming compound lens 30 have an axial length L, the distance between face 42 of lens element 38-1 and face 44 of lens element 38-n of less than or equal to 10 mm. In some implementations, the series of lens elements 38 has an axial length L of less than or equal to 6 mm.

Image sensor 56 comprise a device that outputs electronic signals based upon the imaging of object 50 by compound lens 30. In one implementation, image sensor 56 may comprise a charge coupled device that provide such image sensing. In other implementations, in sensor 56 may comprise other sensing devices.

Controller 270 comprises a processing unit that follows instructions contained in a non-transitory computerize readable medium to receive signals from image sensor 56 and utilize such signals to identify characteristics of the imaged object 50. In one implementation, controller 270 may comprise logic circuitry or logic elements to carry out such functions. In one implementation, controller 270 may compare the identified image based upon the signals from image sensor 56 with predefined thresholds regarding dimensions, surfaces or contours to perform quality control and analysis with respect to object 50. For example, in some implementation, controller 270 may perform quality control over the object formed by an additive manufacturing system in another implementation, controller 270 may perform quality control over the quality of the image printed or otherwise formed upon a medium. In yet other implementations, controller 270 may perform quality control with regard to other two-dimensional or three-dimensional objects. It still other implementations, controller 270 may utilize signals from image sensor 56 to control the operation of object 50 or the formation of object 50. In still other implementations, controller 270 may utilize signals from image sensor 56 for a variety of other purposes.

FIG. 4 is a schematic diagram illustrating another example imaging system 310. Imaging system 310 is similar to imaging system 210 except that imaging system is illustrated as specifically comprising a compound lens 330. As with all of the described imaging systems and compound lens, FIG. 4 further illustrates that the orientation of object support 214, image sensor 56 and controller 270 may vary. FIG. 4 illustrates housing 212 locating object support 214 so as to support object 50 in a vertical orientation, with object 50 resting upon object support 214. Housing 212 in imaging system 310 may support each of the components of imaging system 310 with relative spacing as described above with respect to imaging system to 10. The compact arrangement of imaging system 310 facilitated by compound lens 330 may reduce the overall height of imaging system 310.

Compound lens 330 is similar to compound lens 30 described above except that compound lens 330 is specifically illustrated as comprising the illustrated intermediate and penultimate lens element 38-(n−1). The remaining lens elements of compound lens 330 are similar to the lens elements described above with respect to compound lens 30. As with compound lens 30, each of the lens elements of compound lens 330 have opposite faces that are both aspherical. As with compound lens 30, compound lens element 330 has an end-most or last lens elements 38-n that has at least one face that has a diffractive optic.

In the example illustrated, the penultimate lens element 38-(n−1) is meniscus shaped. The outermost or inmost edges of lens element 38-(n−1) are spaced by air from the last lens element 38-n by a distance of less than 0.5 mm. This close proximity and the meniscus shape facilitates several advantages. Firstly, the meniscus shape (from a manufacturing perspective) is easier to injection mold. Secondly, the shape helps minimize the optical aberrations. Thirdly, it minimizes the length of the lens (L). In one implementation, compound lens 330 comprises a series 334 of three lens elements (n=3). In such an implementation, the meniscus lens element 38-(n−1) is 38-2. In such implementations, the first and middle lens elements, 38-1 and 38-2 may be formed from the same material of the last lens element, lens element 38-3 is formed from a different material. In one implementation, the first and middle lens elements have different Abbe numbers. In one implementation, the first and middle or second lens elements are formed from a material having a low index of refraction and a large Abbe number while the third or last lens element has a larger index of refraction and a lower Abbe number. For example, in one implementation, the first and middle lens elements may be formed from a glass such as SK16 glass (having an index of refraction of 1.620 at 587.6 nm; Abbe Number 60.32) while the last lens element 38-3 is formed from a glass such as SF4 (having an index of refraction of 1.755 at 587.6 nm; Abbe Number 27.38).

In another implementation, series 334 comprises four lens elements (n=4). In such implementations, compound lens 30 may provide a larger field-of-view as compared to a three lens element compound lens 30. For example, in one implementation, the aforementioned three lens element compound lens 330 may provide a field-of-view of 5 mm×5 mm. A four lens element compound lens 330 may provide a field-of-view of 10 mm×10 mm.

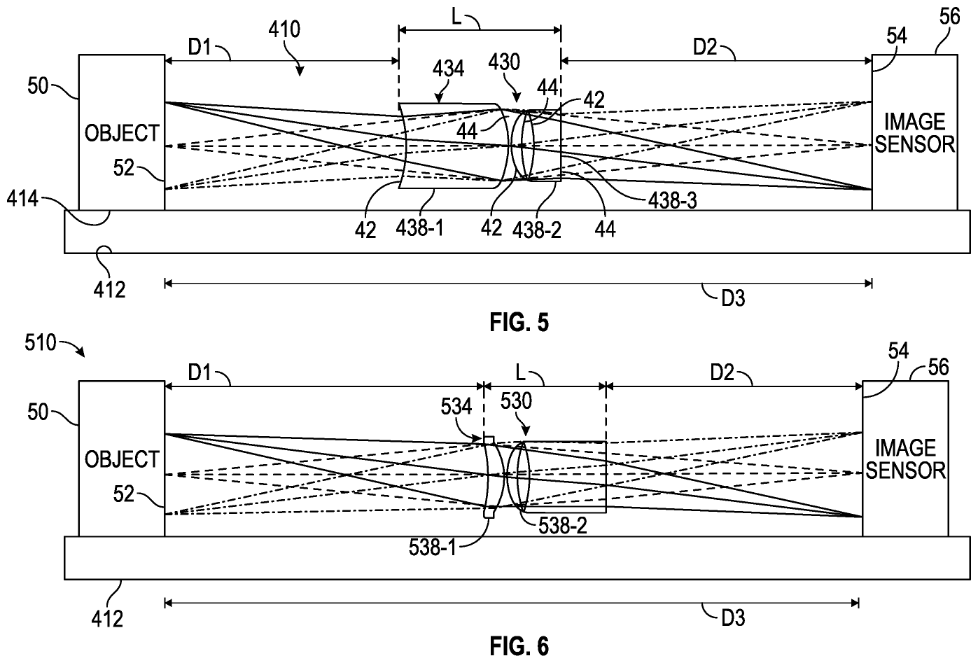

FIG. 5 is a schematic diagram illustrating portions of another example imaging system 410. FIG. 5 illustrates imaging of an object onto an image sensor by an example compound lens. Imaging system 410 comprises housing 412 providing an object support 414, compound lens 430, image sensor 56 (described above) and controller 56 (schematically shown and described above with respect to imaging systems 210 and 310). Housing support 412 supports the components of imaging system 410 relative to one another.

Compound lens 430 is formed from three lens elements 438-1, 438-2 and 438-3 (collectively referred to as lens elements 438). In one implementation, housing 412 supports the series 434 of lens elements 438 of compound lens 430 relative to one another and relative to objects support 414 and image sensor 56 such that the series of lens elements 438 forming compound lens 430 have an axial length L, the distance between face 42 of lens element 438-1 and face 44 of lens element 38-3 of less than or equal to 10 mm.

Each of the lens elements 438 has an object side face 42 and an opposite sensor side face 44. Faces 42 and 44 of each of lens elements 438 are each aspheric. In the example illustrated, lens element 438-1 has a face 42 having a negative power. In one implementation, face 42 of lens element 438-1 is concave.

Lens element 438-2 comprise a meniscus-shaped lens. Similar to lens element 38-(n−1) of imaging system 310, lens elements 438-2 has an outer peripheral edge is axially spaced from surface 44 of lens element 438-3 by a distance of less than 0.5 mm. In one implementation, the first and middle lens elements, 438-1 and 438-2, may be formed from the same material while the last lens element, lens element 438-3, is formed from a different material. In one implementation, the first and middle lens elements 43-1 and 438-2 have different Abbe numbers. In one implementation, the first and middle or second lens elements 438-1, 438-2 are formed from a material having a low index of refraction and a large Abbe number while the third or last lens element has a larger index of refraction and a lower Abbe number. For example, in one implementation, the first and middle lens elements 43-1 and 438-2 may be formed from a glass such as SK16 glass (having an index of refraction of 1.620 at 587.6 nm; Abbe Number 60.32) while the last lens element 438-3 is formed from a glass such as SF4 (having an index of refraction of 1.755 at 587.6 nm; Abbe Number 27.38), wherein each of such lens elements are separated by air. Each of the materials for the lens elements described above as well as for the lens elements described hereafter having the described optical properties (index of refraction and Abbe number) are commercially available from Schott having a corporate office at Elmsford, N.Y. or Ohara Corporation having a corporate office at Rancho Santa Margarita Calif.

Lens element 438-3 extends closest to image sensor 56. Faces 42 and 44 of lens element 438-3 both have a diffractive optic.

In the example illustrated, housing 412 supports object support 414 such that the object 50 to be supported by object support 414 is spaced from the face 42 of the lens element closest to the object plane 52, face 42 of lens element 438-1, by the distance D1 of less than 15 mm. In some implementations, housing 212 locates object support 214 such that the object 50 may be supported within 43 mm from the imaging surface 54 of the imaging sensor 56. In one implementation, housing 412 supports compound lens 430 and image sensor 56 relative to one another such that the face 44 of the lens element closest to image plane 54, face 44 of lens element 38-n, is be spaced from image plane 54 by a distance D2 of less than 19 mm. In one implementation, housing 412 locates object support 214, compound lens 430 and image sensor 56 such that image plane 54 of image sensor 56 is spaced from object plane 52 by a distance D3 (sometimes referred to as a conjugate length) of less than 43 mm.

Below are example specifications for each of the lens elements 438, wherein surface 42 of lens element 438-1 is surface #3, wherein surface 44 of lens elements 438-1 is surface #4, wherein surface 42 of lens element 438-2 is surface #5, wherein surface 44 of lens element 438-2 is surface #6, wherein surface 42 of lens @438-3 is surface #7 and wherein surface 44 of lens element 438-3 is surface #8.

| | RADIUS | | APERTURE_RAD | |
|---|---|---|---|---|
| SRF | (mm) | THICKNESS (mm) | (mm) | GLASS |
| OBJ | — | 14 | 2.5 | AIR |
| 1 | — | — | 1.326508 | AIR |
| 2 | — | — | 1.6 | AIR |
| 3 | −0.178292 | 5.96011 | 2.4 | SK16 |
| AST | −2.753524 | 0.1 | 2.4 | AIR |
| 5 | 3.592678 | 0.578336 | 2.4 | SK16 |
| 6 | 0.134951 | 0.8 | 2.4 | AIR |
| 7 | −3.003003 | 1.476136 | 1.6 | SF4 |
| 8 | −442.089643 | 18.035 | 2 | AIR |
| IMS | — | | — | |

OBJ = Object;
AST = Aperture Stop;
IMS = Image Surface;
Glass types Schott:

*CONIC AND POLYNOMIAL ASPHERIC DATA

| SRF | CC | AD | AE | AF | AG |
|---|---|---|---|---|---|
| 3 | −1.00E+00 | — | — | — | — |
| 4 | −4.83E+00 | — | — | — | — |
| 5 | −3.64E+00 | — | — | — | — |
| 6 | −1.01E+00 | — | — | — | — |
| 7 | 3.61E−01 | — | — | — | — |
| 8 | 1.76E+04 | — | — | — | — |

*ASPHERIC SURFACE DATA

| | | | | | |
|---|---|---|---|---|---|
| as0 | as1 | as2 | as3 | as4 | as5 |

3 ASP ASR 10-SYMMETRIC GENERAL ASPHERE

| | | | | | |
|---|---|---|---|---|---|
| — | 2.73E+00 | −7.85E−02 | 4.29E−03 | −2.58E−04 | 1.14E−05 |

4 ASP ASR 10-SYMMETRIC GENERAL ASPHERE

| | | | | | |
|---|---|---|---|---|---|
| — | 2.25E−02 | −5.32E−03 | 6.65E−04 | −4.46E−05 | 1.83E−06 |

5 ASP ASR 10-SYMMETRIC GENERAL ASPHERE

| | | | | | |
|---|---|---|---|---|---|
| — | 6.61E−03 | 5.78E−03 | 3.58E−06 | 7.49E−05 | −6.35E−07 |

6 ASP ASR 10-SYMMETRIC GENERAL ASPHERE

| | | | | | |
|---|---|---|---|---|---|
| — | −3.56E+00 | 2.50E−01 | −3.17E−02 | 3.97E−03 | −2.54E−04 |

7 ASP ASR 10-SYMMETRIC GENERAL ASPHERE

| | | | | | |
|---|---|---|---|---|---|
| — | 7.16E−02 | 2.50E−02 | −2.36E−03 | 7.05E−04 | −5.52E−05 |

8 ASP ASR 10-SYMMETRIC GENERAL ASPHERE

| | | | | | |
|---|---|---|---|---|---|
| — | −3.61E−02 | 1.29E−02 | −3.45E−04 | 2.06E−04 | −2.19E−05 |

| *Diffractive Surface Data [symbol] | | | | | | |
|---|---|---|---|---|---|---|
| 7 DOE DFR 10-SYMMETRIC DIFFRACTIVE | | | | | [symbol] | [symbol] |
| SRF [symbol] DOR [symbol] 1 DWV [symbol] 5.4000e−01 [symbol] | | | | | [symbol] | [symbol] |
| KCO [symbol] 1 KDP [symbol] 6.2000e−04 [symbol] | | | | | [symbol] | [symbol] |
| DF0 [symbol] | DF1 [symbol] | DF2 [symbol] | DF3 [symbol] | DF4 [symbol] | DF5 [symbol] | [symbol] |
| — [symbol] | −5.78E−03 [symbol] | 1.03E−03 [symbol] | −1.83E−04 [symbol] | 1.15E−05 [symbol] | — [symbol] | [symbol] |
| 8 DOE DFR 10-SYMMETRIC DIFFRACTIVE SRF | | | | | [symbol] | [symbol] |
| DOR 1 DWV 5.4000e−01 [symbol] | | | | | | |
| KCO [symbol] 1 KDP [symbol] 5.4000e−04 [symbol] | | | | | [symbol] | [symbol] |
| — [symbol] | 3.94E−03 [symbol] | −1.60E− [symbol] | 1.26E−05 [symbol] | 3.51E−0 [symbol] | — [symbol] | [symbol] |

[symbol]

indicates data missing or illegible when filed

| Diffraction Zones-Surface 7: PHASE | | | | | |
|---|---|---|---|---|---|
| INCREMENT PER ZONE = 1.000000 x 2 PI [symbol] | | | | | [symbol] |
| Zone Number [symbol] | Zone Radius (mm) [symbol] | [symbol] | [symbol] | [symbol] | [symbol] |
| 0 [symbol] | 0 [symbol] | [symbol] | [symbol] | [symbol] | [symbol] |
| 1 [symbol] | 0.308241 [symbol] | [symbol] | [symbol] | [symbol] | [symbol] |
| 2 [symbol] | 0.43965 [symbol] | [symbol] | [symbol] | [symbol] | [symbol] |
| 3 [symbol] | 0.543138 [symbol] | [symbol] | [symbol] | [symbol] | [symbol] |
| 4 [symbol] | 0.632684 [symbol] | [symbol] | [symbol] | [symbol] | [symbol] |
| 5 [symbol] | 0.713667 [symbol] | [symbol] | [symbol] | [symbol] | [symbol] |
| 6 [symbol] | 0.788819 [symbol] | [symbol] | [symbol] | [symbol] | [symbol] |
| 7 [symbol] | 0.859749 [symbol] | [symbol] | [symbol] | [symbol] | [symbol] |
| 8 [symbol] | 0.927485 [symbol] | [symbol] | [symbol] | [symbol] | [symbol] |
| 9 [symbol] | 0.992724 [symbol] | [symbol] | [symbol] | [symbol] | [symbol] |
| 10 [symbol] | 1.05505 [symbol] | [symbol] | [symbol] | [symbol] | [symbol] |
| 11 [symbol] | 1.117505 [symbol] | [symbol] | [symbol] | [symbol] | [symbol] |
| 12 [symbol] | 1.177629 [symbol] | [symbol] | [symbol] | [symbol] | [symbol] |
| 13 [symbol] | 1.236482 [symbol] | [symbol] | [symbol] | [symbol] | [symbol] |
| 14 [symbol] | 1.294166 [symbol] | [symbol] | [symbol] | [symbol] | [symbol] |
| 15 [symbol] | 1.658738 [symbol] | [symbol] | [symbol] | [symbol] | [symbol] |
| 16 [symbol] | 1.406218 [symbol] | [symbol] | [symbol] | [symbol] | [symbol] |
| 17 [symbol] | 1.46059 [symbol] | [symbol] | [symbol] | [symbol] | [symbol] |
| 18 [symbol] | 1.513839 [symbol] | [symbol] | [symbol] | [symbol] | [symbol] |
| 19 [symbol] | 1.565928 [symbol] | [symbol] | [symbol] | [symbol] | [symbol] |

[symbol]

indicates data missing or illegible when filed

| Diffraction Zones-Surface 8: | | | | | |
|---|---|---|---|---|---|
| PHASE INCREMENT PER ZONE = 1.000000 x 2 PI [symbol] | | | | | [symbol] |
| 0 [symbol] | 0 [symbol] | [symbol] | [symbol] | [symbol] | [symbol] |
| 1 [symbol] | 0.371352 [symbol] | [symbol] | [symbol] | [symbol] | [symbol] |
| 2 [symbol] | 0.526618 [symbol] | [symbol] | [symbol] | [symbol] | [symbol] |
| 3 [symbol] | 0.646728 [symbol] | [symbol] | [symbol] | [symbol] | [symbol] |
| 4 [symbol] | 0.748775 [symbol] | [symbol] | [symbol] | [symbol] | [symbol] |
| 5 [symbol] | 0.839348 [symbol] | [symbol] | [symbol] | [symbol] | [symbol] |
| 6 [symbol] | 0.921801 [symbol] | [symbol] | [symbol] | [symbol] | [symbol] |
| 7 [symbol] | 0.998108 [symbol] | [symbol] | [symbol] | [symbol] | [symbol] |
| 8 [symbol] | 1.069541 [symbol] | [symbol] | [symbol] | [symbol] | [symbol] |
| 9 [symbol] | 1.136964 [symbol] | [symbol] | [symbol] | [symbol] | [symbol] |
| 10 [symbol] | 1.200995 [symbol] | [symbol] | [symbol] | [symbol] | [symbol] |
| 11 [symbol] | 1.262086 [symbol] | [symbol] | [symbol] | [symbol] | [symbol] |
| 12 [symbol] | 1.320576 [symbol] | [symbol] | [symbol] | [symbol] | [symbol] |
| 13 [symbol] | 1.376721 [symbol] | [symbol] | [symbol] | [symbol] | [symbol] |
| 14 [symbol] | 1.430721 [symbol] | [symbol] | [symbol] | [symbol] | [symbol] |
| 15 [symbol] | 1.48273 [symbol] | [symbol] | [symbol] | [symbol] | [symbol] |
| 16 [symbol] | 1.532871 [symbol] | [symbol] | [symbol] | [symbol] | [symbol] |
| 17 [symbol] | 1.581241 [symbol] | [symbol] | [symbol] | [symbol] | [symbol] |
| 18 [symbol] | 1.627919 [symbol] | [symbol] | [symbol] | [symbol] | [symbol] |
| 19 [symbol] | 1.672972 [symbol] | [symbol] | [symbol] | [symbol] | [symbol] |
| 20 [symbol] | 1.716454 [symbol] | [symbol] | [symbol] | [symbol] | [symbol] |
| 21 [symbol] | 1.758417 [symbol] | [symbol] | [symbol] | [symbol] | [symbol] |
| 22 [symbol] | 1.798905 [symbol] | [symbol] | [symbol] | [symbol] | [symbol] |
| 23 [symbol] | 1.837964 [symbol] | [symbol] | [symbol] | [symbol] | [symbol] |
| 24 [symbol] | 1.875634 [symbol] | [symbol] | [symbol] | [symbol] | [symbol] |
| 25 [symbol] | 1.911958 [symbol] | [symbol] | [symbol] | [symbol] | [symbol] |
| 26 [symbol] | 1.946979 [symbol] | [symbol] | [symbol] | [symbol] | [symbol] |
| 27 [symbol] | 1.980741 [symbol] | [symbol] | [symbol] | [symbol] | [symbol] |

[symbol]

indicates data missing or illegible when filed

### Definitions of Constants

Symmetric Surfaces
Conics
A spherical surface is a special case of the general “quadric of revolution” surface. This family of surfaces is determined by two parameters: the curvature (cv) and the conic constant (cc). The type of quadric depends upon the value of the conic constant as follows:

| | |
|---|---|
| cc > 0 | Oblate spheroid |
| cc = 0 | Sphere |
| −1 < cc < 0 | Ellipsoid* |
| cc = −1 | Paraboloid |
| cc < −1 | Hyperboloid |

Symmetric General Asphere is an expansion in r\hat{ }2:

$$z = \frac{{cvr}^{2}}{1 + \sqrt{1 - {cv}^{2} ( cc + 1 ) {r}^{2}}} + as 0 + as 1 {r}^{2} + as 2 {r}^{4} + as 3 {r}^{6} + as 4 {r}^{8} + as 5 {r}^{10} + …$$

Symmetric (even-order) (DFR)—Diffraction Surfaces 7 & 8.
The DFR surface consists of a rotationally-symmetric phase distribution in even powers of the radial coordinate:

$$φ ( r ) = dor \frac{2 π}{{λ}_{0}} ( df 0 + df 1 {r}^{2} + df 2 {r}^{4} + df 3 {r}^{6} + df 4 {r}^{8} + … )$$

$$where$$

$${r}^{2} = {x}^{2} + {y}^{2}$$

Diffraction Zones—Surface 7:
DIFFRACTIVE SURFACE ZONE RADII
SURFACE 7 UNITS: mm
PHASE INCREMENT PER ZONE=1.000000×2 PI

The compound lens 430 of FIG. 5 has a field of vision a 5 mm×5 mm and a magnification of −1.0. The compound lens 430 is to image an object 50 in an object plane 52 onto image sensor 56 at a resolution of at least 150 line pair/mm at a minimum modulation of 0.40 as applied to the object plane.

FIG. 6 is a schematic diagram of portions of another example imaging system 510. Imaging system 510 is similar to imaging system 410 except that imaging system 510 comprises compound lens 530 in place of compound lens 430. Those remaining components of imaging system 510 which correspond to components of imaging system 410 are numbered similarly.

Compound lens 530 comprises lens elements 538-1, 538-2 and 538-3 (collectively referred to as lens elements 538). In one implementation, housing 412 supports the series 534 of lens elements 538 of compound lens 430 relative to one another and relative to objects support 414 and image sensor 56 such that the series of lens elements 538 forming compound lens 530 have an axial length L, the distance between face 42 of lens element 538-1 and face 44 of lens element 538-3 of less than or equal to 8 mm.

Each of the lens elements 538 has an object side face 42 and an opposite sensor side face 44. Faces 42 and 44 of each of lens elements 538 are each aspheric. In the example illustrated, lens element 538-1 has a face 42 having a negative power. In one implementation, face 42 of lens element 538-1 is concave.

Lens element 538-2 comprise a meniscus-shaped lens. Similar to lens element 38-(n−1) of imaging system 310, lens elements 538-2 has an outer peripheral edge is axially spaced from surface 44 of lens element 538-3 by a distance of less than 0.5 mm. In one implementation, the first and middle lens elements, 538-1 and 538-2, may be formed from the same material while the last lens element, lens element 538-3, is formed from a different material. In one implementation, the first and middle lens elements 43-1 and 438-2 have different Abbe numbers. In one implementation, the first and middle or second lens elements 538-1, 538-2 are formed from a material having a low index of refraction and a large Abbe number while the third or last lens element has a larger index of refraction and a lower Abbe number. For example, in one implementation, the first and middle lens elements 538-1 and 538-2 may be formed from a glass such as SK16 glass (having an index of refraction of 1.620 at 587.6 nm; Abbe Number 60.32) while the last lens element 538-3 is formed from a glass such as SF4 (having an index of refraction of 1.755 at 587.6 nm; Abbe Number 27.38), wherein each of such lens elements are separated by air.

Lens element 538-3 extends closest to image sensor 56. Faces 42 and 44 of lens element 538-3 both have a diffractive optic.

The compound lens 530 of FIG. 6 has a field of vision a 5 mm×5 mm and a magnification of −1.0. The compound lens 530 is to image an object 50 in an object plane 52 onto image sensor 56 at a resolution of at least 150 line pair/mm at a minimum modulation of 0.40 as applied to the object plane.

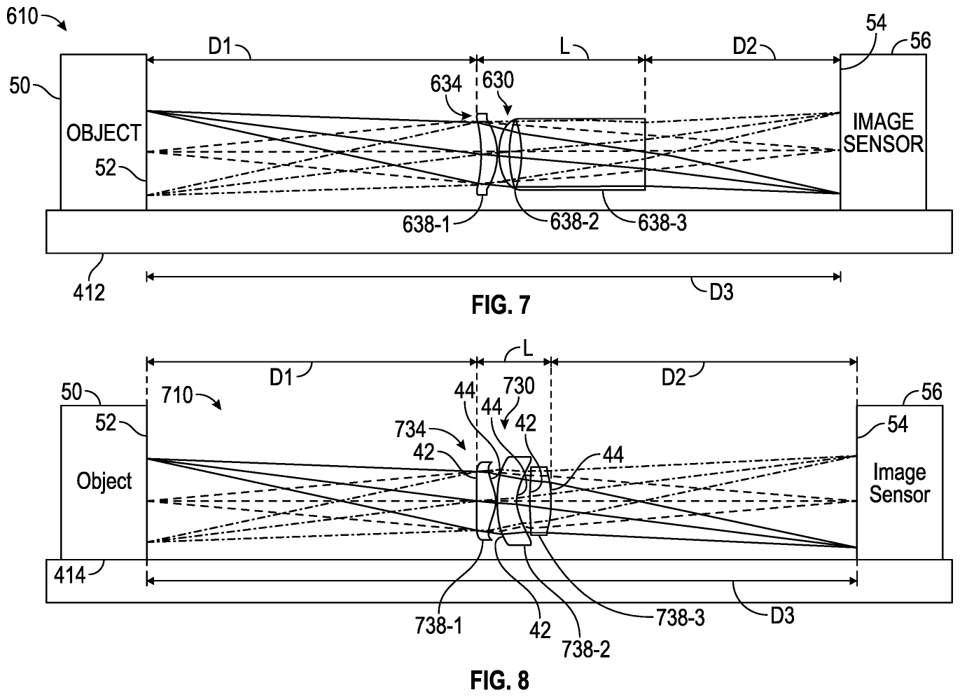

FIG. 7 is a schematic diagram of portions of another example imaging system 610. Imaging system 610 is similar to imaging system 410 except that imaging system 610 comprises compound lens 630 in place of compound lens 430. Those remaining components of imaging system 610 which correspond to components of imaging system 410 are numbered similarly.

Compound lens 630 comprises lens elements 638-1, 638-2 and 638-3. In one implementation, housing 412 supports the series 634 of lens elements 638 of compound lens 630 relative to one another and relative to objects support 41 and image sensor 56 such that the series of lens elements 638 forming compound lens 630 have an axial length L, the distance between face 42 of lens element 638-1 and face 44 of lens element 638-3 of less than or equal to 10 mm.

Each of the lens elements 638 has an object side face 42 and an opposite sensor side face 44. Faces 42 and 44 of each of lens elements 638 are each aspheric. In the example illustrated, lens element 638-1 has a face 42 having a negative power. In one implementation, face 42 of lens element 638-1 is concave.

Lens element 638-2 comprise a meniscus-shaped lens. Similar to lens element 38-(n−1) of imaging system 310, lens elements 638-2 has an outer peripheral edge is axially spaced from surface 44 of lens element 638-3 by a distance of less than 0.5 mm. In one implementation, the first and middle lens elements, 638-1 and 638-2 may be formed from the same material while the last lens element, lens element 638-3, is formed from a different material. In one implementation, the first and middle lens elements 638-1 and 638-2 have different Abbe numbers. In one implementation, the first and middle or second lens elements 638-1, 638-2 are formed from a material having a low index of refraction and a large Abbe number while the third or last lens element has a larger index of refraction and a lower Abbe number. For example, in one implementation, the first and middle lens elements 638-1 and 638-2 may be formed from a glass such as SK16 glass (having an index of refraction of 1.620 at 587.6 nm; Abbe Number 60.32) while the last lens element 638-3 is formed from a glass such as SF4 (having an index of refraction of 1.755 at 587.6 nm; Abbe Number 27.38), wherein each of such lens elements are separated by air.

Lens element 638-3 extends closest to image sensor 56. Faces 42 and 44 of lens element 638-3 both have a diffractive optic.

The compound lens 630 of FIG. 7 has a field of vision a 5 mm×5 mm and a magnification of −1.0. The compound lens 530 is to image an object 50 in an object plane 52 onto image sensor 56 at a resolution of at least 150 line pair/mm at a minimum modulation of 0.40 as applied to the object plane.

FIG. 8 is a schematic diagram of portions of another example imaging system 710. Imaging system 710 is similar to imaging system 410 except that imaging system 710 comprises compound lens 730 in place of compound lens 430. Those remaining components of imaging system 710 which correspond to components of imaging system 410 are numbered similarly.

Compound lens 730 comprises lens elements 738-1, 738-2 and 738-3. In one implementation, housing 412 supports the series 734 of lens elements 738 of compound lens 730 relative to one another and relative to objects support 41 and image sensor 56 such that the series of lens elements 738 forming compound lens 730 have an axial length L, the distance between face 42 of lens element 738-1 and face 44 of lens element 738-3 of less than or equal to 5 mm.

Each of the lens elements 738 has an object side face 42 and an opposite sensor side face 44. Faces 42 and 44 of each of lens elements 738 are each aspheric. In the example illustrated, lens element 738-1 has a face 42 having a negative power. In one implementation, face 42 of lens element 738-1 is concave.

Lens element 738-2 has an outer peripheral edge is axially spaced from surface 44 of lens element 738-3 by a distance of less than 0.5 mm. In the example illustrated, each of the lens elements 738 are formed from different materials. In the example illustrated, the first lens element 738-1 is formed from a SK16 class. The second lens elements 738-2 is formed from a SF2 glass. The last lens elements 738-3 is formed from quartz. Lens element 638-3 extends closest to image sensor 56. Faces 42 and 44 of lens element 638-3 both have a diffractive optic.

The compound lens 730 of FIG. 8 has a field of vision a 5 mm×5 mm and a magnification of −1.0. The compound lens 730 is to image an object 50 in an object plane 52 onto image sensor 56 at a resolution of at least 150 line pair/mm at a minimum modulation of 0.40 as applied to the object plane.

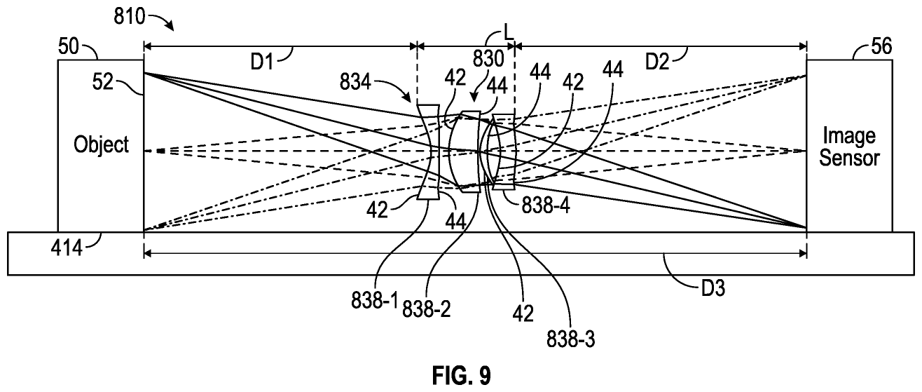

FIGS. 9-11 illustrate the use of compound lenses, each compound lens having four lens elements. The larger number of lens elements increases a field of vision. In each of the examples in FIGS. 8-10, the field of vision is increased to 10 mm×10 mm.

FIG. 9 schematically illustrates imaging system 810. Imaging system 810 is similar to imaging system 410 except that imaging system 810 comprises compound lens 830 in place of compound lens 430. Those remaining components of imaging system 810 which correspond to components of imaging system 410 are numbered similarly.

Compound lens 830 comprises lens elements 838-1, 838-2, 838-3 and 838-4 (collectively referred to as lens elements 838). In one implementation, housing 412 supports the series 834 of lens elements 838 of compound lens 830 relative to one another and relative to objects support 41 and image sensor 56 such that the series of lens elements 838 forming compound lens 830 have an axial length L, the distance between face 42 of lens element 838-1 and face 44 of lens element 838-4 of less than or equal to 6 mm.

Each of the lens elements 838 has an object side face 42 and an opposite sensor side face 44. Faces 42 and 44 of each of lens elements 838 are each aspheric. In the example illustrated, lens element 838-1 has a face 42 having a negative power. In one implementation, face 42 of lens element 838-1 is concave.

Lens element 838-2 is located between lens elements 838-1 and lens element 838-3. Lens element 838-2 increases the field of vision of compound lens 830.

Lens element 838-3 comprise a meniscus-shaped lens. Similar to lens element 38-(n−1) of imaging system 310, lens elements 838-3 has an outer peripheral edge is axially spaced from surface 44 of the final lens element, lens element 838-4, by a distance of less than 0.5 mm. In the example illustrated, each of the lens elements are formed from a different material. In one implementation, lens element 838-1 is formed from an F14 glass; lens element 838-2 is formed from an L-LAH83 glass; lens element 838-3 is formed from an O S-FPL52 glass and lens element 838-4 is formed from an SFL57 glass.

Lens element 838-4 extends closest to image sensor 56. Faces 42 and 44 of lens element 838-4 both have a diffractive optic.

The compound lens 830 of FIG. 9 has a field of vision a 10 mm×10 mm and a magnification of −0.97. The compound lens 830 is to image an object 50 in an object plane 52 onto image sensor 56 at a resolution of at least 150 line pair/mm at a minimum modulation of 0.39 as applied to the object plane.

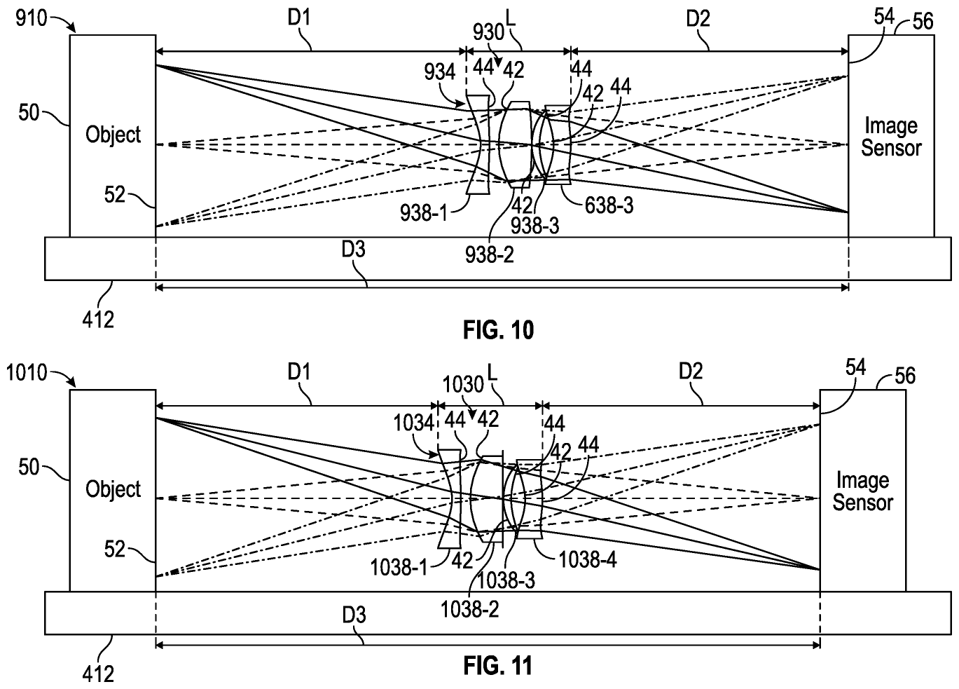

FIG. 10 schematically illustrates imaging system 910. Imaging system 910 is similar to imaging system 810 except that imaging system 910 comprises compound lens 930 in place of compound lens 830. Those remaining components of imaging system 810 which correspond to components of imaging system 810 are numbered similarly.

Compound lens 830 comprises lens elements 938-1, 938-2, 938-3 and 938-4 (collectively referred to as lens elements 938). In one implementation, housing 412 supports the series 934 of lens elements 938 of compound lens 930 relative to one another and relative to objects support 414 and image sensor 56 such that the series of lens elements 938 forming compound lens 930 have an axial length L, the distance between face 42 of lens element 938-1 and face 44 of lens element 938-4 of less than or equal to 7 mm.

Each of the lens elements 938 has an object side face 42 and an opposite sensor side face 44. Faces 42 and 44 of each of lens elements 938 are each aspheric. In the example illustrated, lens element 938-1 has a face 42 having a negative power. In one implementation, face 42 of lens element 938-1 is concave.

Lens element 938-2 is located between lens elements 938-1 and lens element 938-3. Lens element 938-2 increases the field of vision of compound lens 930.

Lens element 938-3 comprise a meniscus-shaped lens. Similar to lens element 38-(n−1) of imaging system 310, lens elements 938-3 has an outer peripheral edge is axially spaced from surface 44 of the final lens element, lens element 938-4, by a distance of less than 0.5 mm. In the example illustrated, each of the lens elements are formed from a different material. In one implementation, lens element 938-1 is formed from an F14 glass; lens element 938-2 is formed from an L-LAH83 glass; lens element 938-3 is formed from an O S-FPL52 glass and lens element 938-4 is formed from an SFL57 glass.

Lens element 938-4 extends closest to image sensor 56. Faces 42 and 44 of lens element 938-4 both have a diffractive optic.

The compound lens 930 of FIG. 10 has a field of vision a 10 mm×10 mm and a magnification of −0.81. The compound lens 930 is to image an object 50 in an object plane 52 onto image sensor 56 at a resolution of at least 150 line pair/mm at a minimum modulation of 0.39 as applied to the object plane.

FIG. 11 schematically illustrates imaging system 1010. Imaging system 1010 is similar to imaging system 810 except that imaging system 1010 comprises compound lens 1030 in place of compound lens 830. Those remaining components of imaging system 1010 which correspond to components of imaging system 810 are numbered similarly.

Compound lens 1030 comprises lens elements 1038-1, 1038-2, 1038-3 and 1038-4 (collectively referred to as lens elements 1038). In one implementation, housing 412 supports the series 1034 of lens elements 1038 of compound lens 1030 relative to one another and relative to objects support 414 and image sensor 56 such that the series of lens elements 1038 forming compound lens 930 have an axial length L, the distance between face 42 of lens element 1038-1 and face 44 of lens element 1038-4 of less than or equal to 7 mm.

Each of the lens elements 1038 has an object side face 42 and an opposite sensor side face 44. Faces 42 and 44 of each of lens elements 1038 are each aspheric. In the example illustrated, lens element 1038-1 has a face 42 having a negative power. In one implementation, face 42 of lens element 1038-1 is concave.

Lens element 1038-2 is located between lens elements 1038-1 and lens element 1038-3. Lens element 1038-2 increases the field of vision of compound lens 1030.

Lens element 1038-3 comprise a meniscus-shaped lens. Similar to lens element 38-(n−1) of imaging system 310, lens elements 1038-3 has an outer peripheral edge is axially spaced from surface 44 of the final lens element, lens element 1038-4, by a distance of less than 0.5 mm. In the example illustrated, each of the lens elements are formed from a different material. In one implementation, lens element 1038-1 is formed from an F14 glass; lens element 1038-2 is formed from an L-LAH83 glass; lens element 1038-3 is formed from an O S-FPL52 glass and lens element 1038-4 is formed from an SFL57 glass.

Lens element 1038-4 extends closest to image sensor 56. Faces 42 and 44 of lens element 1038-4 both have a diffractive optic.

The compound lens 1030 of FIG. 11 has a field of vision a 10 mm×10 mm and a magnification of −0.92. The compound lens 1030 is to image an object 50 in an object plane 52 onto image sensor 56 at a resolution of at least 150 line pair/mm at a minimum modulation of 0.39 as applied to the object plane.

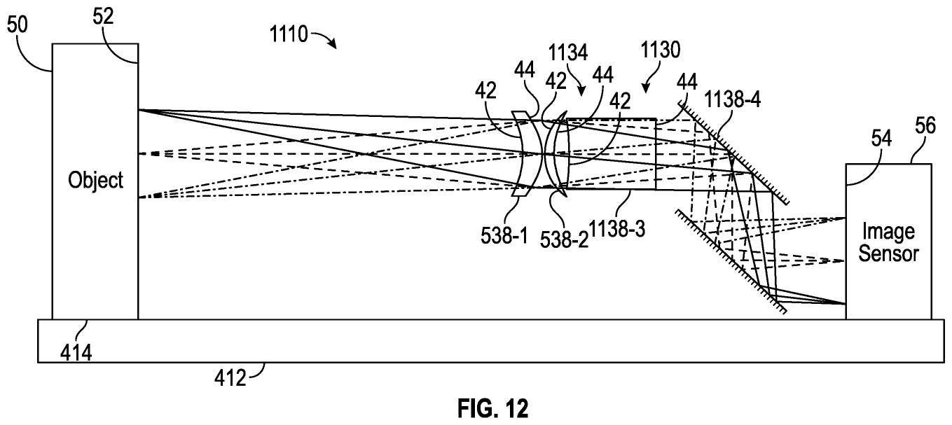

FIG. 12 schematically illustrates another example imaging system 1110. Imaging system 1110 is similar to imaging system 510 described above except that imaging system 1110 comprises compound lens 1130 in place of compound lens 530. Like compound lens 530, compound lens 1130 is to image an object 50 in an object plane 52 onto image sensor 56 at a resolution of at least 150 line pair/mm at a minimum modulation of 0.40 as applied to the object plane.

Compound lens 1130 is similar to compound lens 530 except that compound lens 1130 comprises lens element 1138-3 in place of lens elements 538-3 and further comprises mirrors 1138-4. Those remaining components of compound lens 1130 which correspond to components of compound lens 530 are numbered similarly.

Lens element 1138-3 is similar to lens element 530-3 except that lens element 1138-3 comprises diffractive optic on one face, face 42. In the example illustrated, the omission of a diffractive element on face 44 of lens element 1138-3 is addressed through the addition of mirrors 1138-4. Mirrors 1138-4 comprise diffractive surfaces, wherein the light exiting lens element 1138-3 is reflected off of such mirrors 1138-4 and onto image sensor 56.

Although the present disclosure has been described with reference to example implementations, workers skilled in the art will recognize that changes may be made in form and detail without departing from the spirit and scope of the claimed subject matter. For example, although different example implementations may have been described as including one or more features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. An imaging system comprising:
a compound lens comprising:
a series of lens elements, each of the lens elements having an aspheric surface on each opposite face, wherein the last lens element of the series has a diffractive optic on a face of the last lens element, wherein the compound lens is to image an object in an object plane onto an image sensor at a resolution of at least 150 line pair/mm at a minimum modulation of 0.39 as applied to the object plane across a visible spectrum comprising red, blue and green wavelengths.

2. The imaging system of claim 1, wherein the series of lens elements has a lens surface closest to the object and wherein the compound lens is to image the object in the object plane onto an image sensor at a resolution of at least 150 line pair/mm at a minimum modulation of 0.39 with the object being less than 15 mm from the first lens surface.

3. The imaging system of claim 1, wherein the series of lens elements has a lens surface closest to the object further comprising an object support to support the object at a spacing of less than 15 mm from the lens surface.

4. The imaging system of claim 1 further comprising an image sensor having an image plane, wherein the series of lens elements has a lens surface closest to the image plane and spaced from the image plane by a distance of less than 19 mm.

5. The imaging system of claim 1 further comprising an image sensor having an image plane, wherein the compound lens is to image the object in the object plane onto the image sensor at the resolution of at least 150 line pair/mm at a minimum modulation of 0.39 with the object being less than 43 mm from the imaging surface.

6. The imaging system of claim 1, wherein the compound lens has a magnification between −0.7 and −1.5.

7. The imaging system of claim 1, wherein the compound lens has a magnification between −0.7 and −1.0.

8. The imaging system of claim 1, wherein the compound lens has a magnification of between −1.0 and −1.5.

9. The imaging system of claim 1, wherein the compound lens has a magnification of −0.1.

10. The imaging system of claim 1, wherein the series of lens elements comprise surface to face the object, the surface having a negative power.

11. The imaging system of claim 1, wherein the series of lens elements comprise a last lens element to be proximate the image sensor and a second to last lens element, wherein the second to last lens element is meniscus shaped.

12. The imaging system of claim 11, wherein the second to last lens element has an outer edge spaced by air from the last lens element by a distance of less than 0.5 mm.

13. The imaging system of claim 1, wherein the series of lenses comprise a first lens element to be proximate the object and a second lens element consecutive to the first lens element, the first lens element and the second lens element being formed from a same material.

14. A compound lens for an imaging system, the compound lens comprising:
a series of lens elements comprising:
a first lens element having a first surface to face an object and a second surface opposite the first surface, the first surface having a negative power;
a last lens element having a first surface to face the first lens element sensor and a second surface to face an image sensor, the first surface of the last lens element and the second surface of the last lens element each having a diffractive optic, the first surface of the first lens and the second surface of the last lens being spaced by distance of less than 10 mm, wherein the compound lens is to image an object in an object plane onto the image sensor at a modulation of 0.40 as applied to the object plane across a visible spectrum comprising red, blue and green wavelengths.

15. A method comprising:
aligning a series of lens elements between the object and the image sensor, each of the lens elements having an aspheric surface on each opposite face, the series lens elements comprising a first lens element proximate the object in a last lens element proximate the image sensor, wherein the last lens element has a face having a diffractive optic on each opposite face of the last lens element, wherein the first lens element has a face facing the object and having a negative power and wherein the object in an object plane is imaged onto the image sensor at a resolution of at least 150 line pair/mm at a minimum modulation of 0.39 across a visible spectrum comprising red, blue and green wavelengths; and
sensing the imaged object with the image sensor.
